(19) United States
(12) Patent Application Publication
(10) Pub. No.: US 2026/0079990 A1
(43) Pub. Date: Mar. 19, 2026

(54) TECHNIQUES FOR LARGE LANGUAGE MODEL PROMPT GROUNDING

(71) Applicant: Salesforce, Inc., San Francisco, CA (US)

(72) Inventors: Ajay Singh, Bangalore (IN); Maruthi Shanmugam, Dallas, TX (US); Abhishek Keshri, Hyderabad (IN); Sriram Gopalan, Fremont, CA (US); Varun Kumar Reddy Dodla, Dublin, CA (US); Vikram Babu Kuruguntla, Hyderabad (IN)

(21) Appl. No.: 19/041,829

(22) Filed: Jan. 30, 2025

(30) Foreign Application Priority Data
Sep. 13, 2024 (IN) 202411069576

(51) Int. Cl. G06F 16/338; G06F 16/383; G06F 40/20

(52) U.S. Cl. CPC G06F 16/338; G06F 16/383; G06F 40/20

(57) ABSTRACT

A computing system may receive, via a client interface, a query to trigger a prompt of a set of prompts configured for a large language model (LLM), where the query may be indicative of a set of data from one or more data sources linked to the prompt. The computing system may transmit, to an augmentation service, a request for a set of grounding data associated with the set of data from the data sources linked to the prompt. The computing system may then receive, from the augmentation service, the set of grounding data where the set of grounding data includes hierarchical context data from the data sources. The LLM may then be queried via the prompt using the first set of data and the set of grounding data. The response to the query may then be provided, to the client interface, for display via the client interface.

### CROSS REFERENCE

The present Application for Patent claims priority to and the benefit of Indian Patent Application No. 202411069576 by Singh et al., entitled “TECHNIQUES FOR LARGE LANGUAGE MODEL PROMPT GROUNDING,” filed Sep. 13, 2024, assigned to the assignee hereof, and is expressly incorporated by reference in its entirety herein.

### FIELD OF TECHNOLOGY

The present disclosure relates generally to database systems and data processing, and more specifically to techniques for LLM prompt grounding.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

### BRIEF DESCRIPTION OF THE DRAWINGS

FIG. 1 illustrates an example of a data processing system that supports techniques for large language model (LLM) prompt grounding in accordance with aspects of the present disclosure.

FIG. 2 shows an example of a computing system that supports techniques for LLM prompt grounding in accordance with aspects of the present disclosure.

FIG. 3 shows an example of a process flow that supports techniques for LLM prompt grounding in accordance with aspects of the present disclosure.

FIG. 4 shows a block diagram of an apparatus that supports techniques for LLM prompt grounding in accordance with aspects of the present disclosure.

FIG. 5 shows a block diagram of an LLM architecture service that supports techniques for LLM prompt grounding in accordance with aspects of the present disclosure.

FIG. 6 shows a diagram of a system including a device that supports techniques for LLM prompt grounding in accordance with aspects of the present disclosure.

FIG. 7 shows a flowchart illustrating methods that support techniques for LLM prompt grounding in accordance with aspects of the present disclosure.

### DETAILED DESCRIPTION

In some systems, users may use generative artificial intelligence (AI) applications for tasks such as data summarization, content generation, and information extraction. For example, a generative AI application may use one or more AI and machine learning (ML) models (e.g., AI/ML models), such as a large language model (LLM), to generate content based on a selection of data. In some examples, to query an LLM to perform a respective task, a user may use an LLM prompt that includes a set of instructions for the LLM to perform the respective task. In some cases, administrative users that develop the LLM prompts may have to customize the LLM prompts for specific use cases. A use case may be representative of a field or industry that utilizes an LLM prompt. For example, one use case for an LLM prompt and LLMs may be health care where users may use an LLM prompt to relatively quickly summarize a patient record, and another use case may be the business field where a user can use an LLM prompt to generate emails to prospective customers based on data associated with the prospective customer. Further, while LLM prompts for different use cases may be relatively different, the overall architecture may be similar across multiple different use cases. As such, having administrative users recreate the similar architecture may be relatively inefficient and can result in an increase in cost and an increase in computational resource consumption.

In accordance with the techniques of the present disclosure, a system may provide a unified architecture for using a set of LLM prompt templates for different use cases to improve the efficiency of using such LLM systems. For example, the system may receive, via a client interface, a query to trigger a prompt configured for an LLM where the query may be indicative of a first set of data from one or more data sources linked to the prompt. Further, the system may transmit a request to an augmentation service to obtain a set of grounding data associated with the query from multiple data sources. The system may then use both the initial data from the query and the grounding data to query the LLM to receive a response to the query that may then be provided for display via the client interface. The system may provide a platform to reduce redundant developmental efforts from users and to reduce inefficiencies by standardizing the data processing procedures for using LLMs. Further, the techniques of the present disclosure may assist in reducing resource consumption, enhancing scalability, and can assist in ensuring consistent, accurate, and reliable outputs from LLMs across various different applications.

In some examples, prior to receiving a query, an administrative user may configure the client interface. In some cases, the configuration process may involve the administrative user selecting settings, choosing a set of prompts based on selected settings, and defining labels for the client interface. Providing such configuration may assist in ensuring that the system is customized to meet user-specific needs and use cases, thus enhancing both user experience and operational efficiency. Further, when obtaining the grounding data from the augmentation service, the augmentation service may use one or more data transformers and one or more data refiners to ensure that the data from multiple different data sources are within a common data format. For example, data from a first data source may be associated with a first data format and data from a second data source may be associated with a second data format that is different from and incompatible with the first data format. Thus, the augmentation may use data transformers and data refiners that are associated with the respective data sources to ensure that the grounding data is within a common data format. Moreover, the inclusion of the grounding data into the query to the LLM along with the data from the initial query via the client interface may improve the accuracy and relevance of the response from the LLM by providing additional context and information to the LLM. Thus, the techniques of the present disclosure may provide users with a standardized architecture for querying an LLM efficiently while ensuring accurate and reliable responses for various different use cases.

Aspects of the disclosure are initially described in the context of an environment supporting an on-demand database service. Additional aspects of the disclosure are described with reference to a computing system and a process flow. Aspects of the disclosure are further illustrated by and described with reference to apparatus diagrams, system diagrams, and flowcharts that relate to techniques for LLM prompt grounding.

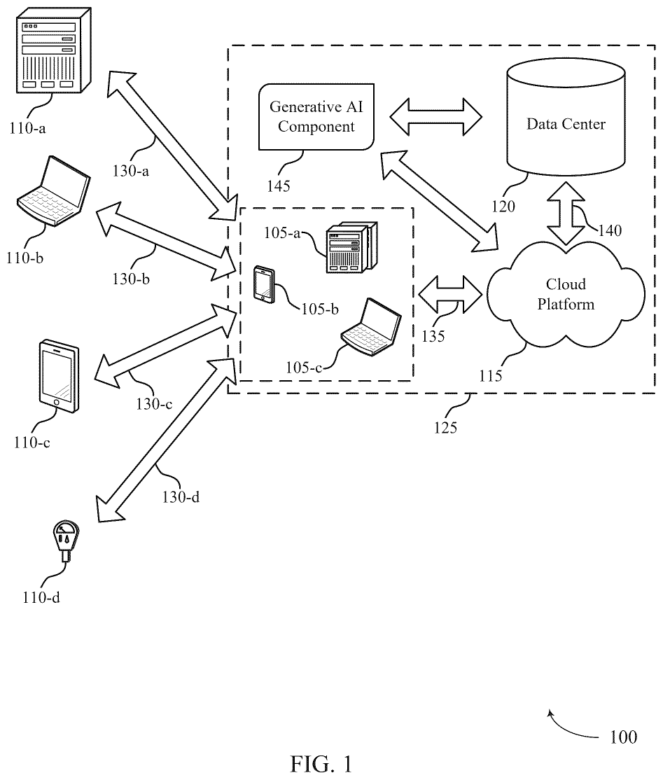

FIG. 1 illustrates an example of a system 100 for cloud computing that supports techniques for LLM prompt grounding in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

Additionally, or alternatively, the system 100 may support the use of a LLM (generative AI model), such as the generative AI component 145. In some examples, a generative AI component 145 may also be referred to as any of an artificial intelligence (AI), a generative AI (GAI), a GAI model, a LLM (LLM). The generative AI component 145 may be a model that is trained on a corpus of input data, which may include text, images, video, audio, structured data, or any combination thereof. Such data may represent general-purpose data, domain-specific data, or any combination thereof. Further, a generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may transmit a prompt to the generative AI component 145 that includes the query (or information included therein) and receive the generated output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located outside of the subsystem 125. However, the generative AI component 145 may be hosted on the cloud platform 115, elsewhere within the subsystem 125, or outside the subsystem 125 (e.g., a publicly-hosted platform). Additionally, or alternatively, the generative AI component 145 may be employed by multiple components to perform one or more of the actions described as being performed by the generative AI component 145 (e.g., a single component). Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In some examples of the system 100, users may utilize generative AI applications, via the generative AI component 145, for tasks such as data summarization, content generation, and information extraction. In some examples, to query an LLM to perform a respective task, a user may use an LLM prompt that includes a set of instructions for the LLM to perform the respective task. In some cases, administrative users that develop the LLM prompts may have to customize the LLM prompts for specific use cases. Further, while LLM prompts for different use cases may be relatively different, the overall architecture may be similar across multiple different use cases. As such, having administrative users recreate the similar architecture may be relatively inefficient and can result in an increase in cost and an increase in computational resource consumption.

In accordance with the techniques of the present disclosure, the system 100 may provide a unified architecture for a set of LLM prompt templates for different use cases to improve the efficiency of using such LLM systems. For example, the system 100 may receive a query to trigger a prompt configured for an LLM where the query may be indicative of a first set of data from one or more data sources linked to the prompt. The system 100 may then transmit a request to an augmentation service to obtain a set of grounding data associated with the query from multiple data sources. The system 100 may then use both the initial data from the query and the grounding data to query the LLM to receive a response to the query that may then be provided for display via the client interface. Thus, in accordance with the techniques of the present disclosure, the system 100 may provide techniques for users to use a common LLM architecture for querying an LLM and receiving accurate and reliable responses from the LLM.

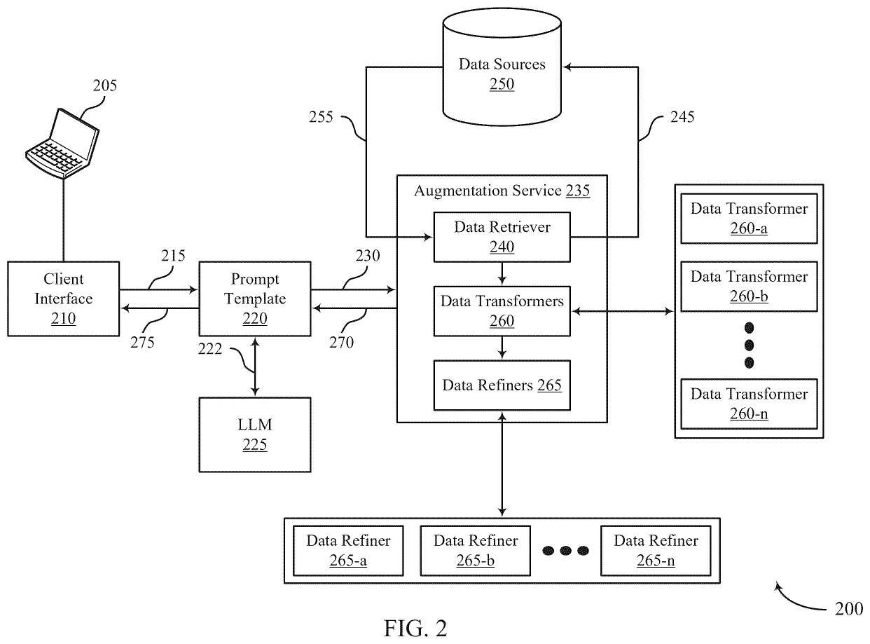

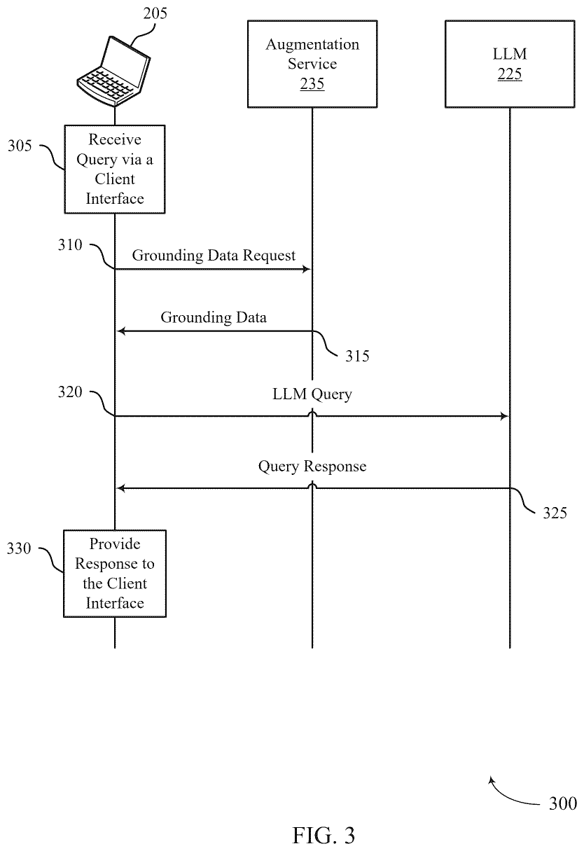

In some examples, a salesperson of an organization may use the system 100 and the generative AI component 145 to generate summaries of a customer data record. For example, the salesperson may transmit a query via a client interface to obtain a summary of activities associated with a respective customer over a period of time. In some examples, the user may also select a prompt from a set of prompts via the client interface for the query. For example, the user may select a prompt template associated with summarizing data. In response, an augmentation service associated with the system 100 may then obtain grounding data for an LLM query to provide additional context and data for querying the LLM to generate a summary of the customer's data. In some examples, the grounding data may include additional information and data on the customer that can be used as inputs to the LLM to assist the LLM in providing relatively more accurate and reliable responses to the user. Thus, the techniques of the present disclosure may provide techniques for the system 100 to use a similar architecture for different use cases and different user types (e.g., users associated with different industries or organizations) while maintaining a relatively high level of accuracy, relevance, and efficiency. Further descriptions of the techniques of the present disclosure utilizing of the system 100 using the generative AI component 145 with multiple different use cases may be described elsewhere herein, such as with reference to FIGS. 2 and 3.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

FIG. 2 shows an example of a computing system 200 that supports techniques for LLM prompt grounding in accordance with aspects of the present disclosure. In some examples, the computing system 200 may implement or may be implemented by the system 100. For example, the computing system 200 may include a computing device 205 and a client interface 210 that may be implemented by devices or services described with reference to FIG. 1 (e.g., a cloud client 105 or a contact 110). Further, the computing system 200 may support the computing device 205 displaying the client interface 210 such that a user may perform one or more operations on the client interface 210 via the computing device 205. The computing system 200 may further include a prompt template 220 associated with an LLM 225, one or more data sources 250, and an augmentation service 235 that includes a data retriever 240, one or more data transformers 260 (e.g., a data transformer 260-a, a data transformer 260-b, and a data transformer 260-n), and one or more data refiners 265 (e.g., a data refiner 265-a, a data refiner 265-b, and a data refiner 265-n).

In some examples, in accordance with the techniques of the present disclosure, the computing system 200 may provide users with a common architectural framework for various different generative AI use cases in order to support a relatively wide array of different user requirements. For example, different sets of users may use generative AI applications to perform similar tasks such as summarization of larger data sets, extraction of specific information from unstructured data, rephrasing content, elaborating on topics for more detailed explanations, generating original content (e.g., content for marketing), customer service, and the like. While the objective of such tasks and the input for a generative AI application to perform a respective task may differ between use cases, as the architecture may be common, the computing system 200 may provide users with the architecture rather than having users develop similar architecture resulting in a waste of time and resources.

In some examples, as a first part of the architecture, the computing device 205 may interact with the client interface 210. In some examples, the client interface 210 may be a customizable user interface that serves as an interface for users (e.g., users of the computing device 205) to interact with generative AI operations (e.g., to interact with the LLM 225). For example, a respective user of the computing device 205 may transmit a query 215 to the client interface 210 to trigger a prompt configured for a generative AI application (e.g., an application associated with the LLM 225). Further, the client interface 210 may be customizable by an administrative user to allow the administrative user to customize how an end-user of the client interface 210 can trigger a prompt for the LLM 225 (e.g., how the end-user can trigger a generative AI processes) and how the end-user can view the responses. Moreover, the client interface 210 may ensure that end-users can relatively easily initiate generative AI tasks and operations such as content generation or data summarization.

In some examples, the LLM 225 may be pre-trained or may be trained for a respective user. For example, an end-user triggering a prompt for the LLM 225 via the client interface 210 may be a salesperson. As such, the LLM 225 may be trained on data associated with products being sold by the user, an organization associated with the user, information about the user, or any combination thereof. Additionally, or alternatively, such training may be a form of fine-tuning of the LLM 225. For example, the LLM 225 may be trained on a relatively large corpus of generic data to establish a baseline training for performing generative AI tasks and processes and then a user or an organization may fine-tune the LLM 225 for a respective use case.

In some cases, the query 215 received via the client interface 210 may be indicative of a first set of data from one or more data sources (e.g., the data sources 250) linked to the prompt. For example, a user may transmit the query 215 via the client interface 210 to trigger a prompt of a set of prompts configured for the LLM 225 to summarize a set of data (e.g., the first set of data). In some examples, to indicate that the query 215 is for summarizing the set of data, the user may select a prompt from a set of prompts where the prompt includes a set of instructions for the LLM 225 to summarize a set of data input into the LLM 225. In some cases, the computing system 200 may provide, to the client interface 210, a display for a user to select a prompt from the set of prompts. Further, the display may enable a user to select a prompt from a list of prompts configured in the client interface 210, where the list of prompts are displayed via the client interface 210 for the user to select from. In some examples, to select a prompt, the user may select an interactive element of the client interface 210 (e.g., a button) to trigger a display of another user interface for the user to select the prompt. Moreover, once the user selects a respective prompt, the computing system 200 may receive, from the client interface 210, an indication of the selection. Further, the reception of the query to trigger the prompt may be based on the prompt selection such that the query 215 may trigger the selected prompt. In some cases, the types of prompts displayed for a user to select from may be associated with different tasks such as content generation, data summarization, and the like. Thus, the respective prompts of the set of prompts configured for the LLM 225 may be configured (e.g., include instructions) to perform respective tasks via the LLM 225. The instructions may include formatting instructions, tone instructions, data source instructions, and other types of instructions.

In some cases, prior to a reception of the query 215 via the client interface 210, an administrative user may configure one or more aspects of the client interface 210 for an end-user. For example, the administrative user may generate a configuration of the client interface 210 that is received by the computing system 200 that includes a selection of one or more query configurations, a selection of a set of prompts that are based on the selection of the one or more query configurations, an indication of one or more labels for the client interface 210, or any combination thereof. In some cases, the one or more query configurations may indicate one or more respective tasks a user can query (e.g., via the query 215) via the client interface 210 to trigger a prompt of an LLM 225. For example, the administrative user may configure the client interface 210 such that a respective user is capable of transmitting a query 215 associated with content generation, data summarization, or both. Further, the administrative user may configure the client interface 210 to limit the prompts that the query 215 from the end-user can trigger. For example, if the administrative user configures the query 215 to be for data summarization, the end-user may be unable to select a prompt to trigger via the query 215 that includes instructions related to content generation. Additionally, or alternatively, the one or more labels for the client interface 210 that an administrative user may configure can include a header label, a button label, an instructions label (e.g., a set of text instructing the end-user on how to use the client interface 210), a disclaimer label, or any combination thereof.

After the client interface 210 receives the query 215, the client interface 210 may transmit the query 215 to a prompt template 220 that communicates with the LLM 225 via an interface 222 (e.g., a data link or other form of data communication or transfer link such as an API). In some examples, the prompt template 220 that the query 215 is sent to may be based on a selection of a prompt from a set of prompts by the user that transmitted the query. For example, if the user selected a prompt for data summarization, the client interface 210 may transmit the query 215 to a prompt template 220 that includes generic instructions for data summarization. In some examples, the prompt template 220 may be used as a template or ‘blueprint’ that is associated with a respective task for the LLM 225 to complete (e.g., summarization, rephrasing, content generation, and the like). Moreover, the prompt template 220 may ensure that the LLM 225 is capable of generating relevant and contextually appropriate outputs in response to the query 215. However, the prompt template 220 may expect to receive an input of grounding data to give additional information and context to the LLM 225 when executing the task associated with the query 215.

For example, when sending the query 215 to the prompt template 220, the data indicated by the query 215 may be input into the prompt template 220. Further, based on inputting the data from the query 215 into the prompt template 220, the prompt template 220, the LLM 225 associated with the prompt template 220, or both, may transmit a grounding data request 230 to the augmentation service 235. In some cases, the grounding data request 230 may include a request for additional data and information to be used as input to the prompt template 220 to enable the LLM 225 to generate an accurate and reliable response to the query 215.

In accordance with the techniques of the present disclosure, the augmentation service 235 may incorporate a framework that is metadata-driven to allow an inclusion of hierarchical context data for a prompt grounding process. The prompt grounding process may ensure that the LLM 225 (e.g., a generative AI model) is provided with a configurable set of relatively high quality information or data that is structured and contextually relevant to the query 215 and the data indicated by the query 215. Thus, the prompt grounding process may enhance the accuracy and relevance of the outputs generated by the LLM 225. To generate the grounding data for the prompt template 220, the augmentation service 235 may use one or more data retrievers 240, one or more data transformers 260, and one or more data refiners 265.

To initiate the process of obtaining the grounding data the one or more data retrievers 240 of the augmentation service 235 may transmit a data request 245 to one or more data sources 250. The one or more data retrievers 240 may configured to fetch (e.g., retrieve or obtain) data from multiple data sources 250. In some cases, the multiple data sources 250 can include internal or external databases, external APIs, or other relevant data repositories. Moreover, the hierarchical context data for the grounding data (e.g., a set of grounding data) may be based on metadata from the one or more data sources 250. Thus, the computing system 200 may utilize the one or more data retrievers 240 to obtain information and data from the one or more data sources 250 to ensure that the responses from the LLM 225 are relatively more accurate and contextually relevant. Additionally, or alternatively, the one or more data sources 250 may include unstructured data sources 250, structured data sources 250, or both. Structured data sources 250 may be data sources 250 that are highly organized, easily searchable, and have standardized formats. Unstructured data sources 250 may be data sources that lack a predefined format or organization.

Further, the one or more data retrievers 240 may receive a data request response 255 from the one or more data sources 250 that includes the data requested via the data request 245. The data obtained from the one or more data sources may be referred to as a set of grounding data elsewhere herein. Further, in some cases, the one or more data sources 250 may store data within various different formats or data structures, thus the augmentation service 235 may have to transform the data obtained from the one or more data retrievers 240 into a common format or data structure. For example, after retrieving the set of grounding data via the one or more data retrievers 240, the augmentation service 235 may transform the data within the set of grounding data to fit requirements associated with a use case associated with the user that requested the query 215. Such transformations may include formatting or reformatting the data, converting the data into a different data structure, enriching the data with additional information, encrypting or decrypting the data, or any combination thereof.

To transform the set of grounding data, the augmentation service 235 may use the one or more data transformers 260. In some examples, each of the one or more data transformers 260 may be associated with a respective data structure. For example, a first data retriever 240 may retrieve data from a first data source 250 and the data may be within a first data format. Thus, the augmentation service may use a data transformer 260-a that is associated with the first data format to transform the data into a common data format. For example, a second data retriever 240 may retrieve data from a second data source 250 where the data is within a second data format that is different from the first data format. Therefore, the augmentation service 235 may use a data transformer 260-b that is associated with the second data format to transform the data into the common data format. Thus, the one or more data transformers 260 may be capable of transforming the data from multiple different data sources 250 that are within different data formats into a single and common data format.

In some examples, the transformed data may have to be further refined or ‘massaged’ to align with respective requirements of a use case. For example, for a health care use case, the data may have to be adjusted or adapted to comply with various ethical codes of conduct associated with the healthcare industry. To refine the data the augmentation service may use the one or more data refiners 265. In some cases, each of the one or more data refiners 265 may be associated with a respective use case or a respective task. For example, the data refiner 265-a may be associated with the healthcare field and may be configured to (e.g., trained to) adjust the set of grounding data to be used for querying the LLM while complying with the healthcare field restrictions. In another example, the data refiner 265-b may be associated with a respective task. For example, the data refiner 265-b may be associated with anonymizing data to remove any personal identifiers from the set of grounding data. Additionally, or alternatively, the data refiners 265 may adjust the set of grounding data to ensure that the data format of the set of grounding data is within a format that is accepted by the LLM 225 and to ensure that the data can assist in enhancing the quality and relevance of the output generated via the LLM 225.

After refining the data to comply with a respective use case and to be within a format accepted by the LLM 225, the augmentation service may transmit a data response 270 to the prompt template 220 that includes the set of grounding data. Based on receiving the data response 270, the set of grounding data retrieved, transformed, and refined by the augmentation service 235 may be used as input to the prompt template 220 along with the set of data indicated via the query 215. Thus, the computing system 200 may query the LLM 225 via the prompt indicated via the prompt template 220 using both the data indicated via the query 215 and the set of grounding data obtained from the one or more data sources 250. The LLM 225 may then execute the set of instructions indicated via the prompt template 220 and generate a query response 275. The computing system 200 may provide the query response 275 to the client interface 210 for display via the client interface 210. For example, the query response 275 that includes the output from the LLM 225 in response to the query 215 may be displayed via the client interface 210. Thus, the computing system 200 may enable a user to transmit a query 215 via the client interface 210 that triggers a prompt of the LLM 225 (e.g., the prompt template 220) and receive the query response 275 that includes the output generated by the LLM 225 and is displayed by the client interface 210.

In some examples, the architecture described herein via the computing system 200 may enable a relatively seamless integration and communication between the client interface 210, the prompt template 220, the LLM 225, and the augmentation service 235. Thus, in accordance with the techniques of the present disclosure, the computing system 200 may ensure that the outputs of the LLM 225 are accurate and contextually relevant. Further, as discussed elsewhere herein, proving the architecture illustrated and described herein may improve the efficiency of utilizing generative AI applications by providing the architecture to users to reduce developmental time and resource consumption. For example, the architecture illustrated by the computing system 200 may be reused for different use cases and scenarios, thus reducing the time associated with developing generative AI applications and tools for these use cases and scenarios. Further, as the different use cases for using generative AI applications continues to increase, having a standardized architecture may enable additional use cases to relatively easily use the generative AI applications, thus improving the scalability of utilization of the architecture described herein. Additionally, or alternatively, having a standardized user experience across different industries and applications may ensure a level of consistency and reliability in outputs from generative AI applications. Further techniques of the present disclosure may be described elsewhere herein, such as with reference to FIG. 3.

FIG. 3 shows an example of a process flow 300 that supports techniques for LLM prompt grounding in accordance with aspects of the present disclosure. In some examples, the process flow 300 may implement or may be implemented by the system 100, the computing system 200, or both. The process flow 300 may include the computing device 205, the augmentation service 235, and the LLM 225 which may be examples of devices or services described elsewhere herein including with reference to FIGS. 1 and 2. Further, one or more users may operate the computing device 205 as described elsewhere herein with reference to FIGS. 1 and 2.

In the following description of the process flow 300, the operations may be performed by the computing device 205, the augmentation service 235, and the LLM 225 in different orders or at different times. Some operations may also be left out of the process flow 300, or other operations may be added. Although the process flow 300 may be described as being performed by the computing device 205, the augmentation service 235, and the LLM 225, some aspects of some operations may also be performed by other devices, services, or models described elsewhere herein including with reference to FIGS. 1 and 2.

At 305, a user of the computing device 205 may transmit, via a client interface, a query to trigger a prompt of a set of prompts configured for a LLM (LLM). The query may be indicative of a first set of data from one or more data sources linked to the prompt. In some cases, the client interface may be a graphical user interface, an application programming interface, or a combination thereof. Additionally, or alternatively, respective prompts of the set of prompts configured for the LLM may be configured to perform respective tasks via the LLM. In some examples, prior to the client interface receiving the query, a user (e.g., an administrative user) may transmit a configuration of a client interface. The configuration may include a selection of one or more query configurations, a selection of a set of prompts based on the selection of the one or more query configurations, an indication of one or more labels for the client interface, or any combination thereof. The reception of a query may be based on the reception of the configuration for the client interface. In another example, a user of the computing device 205 may be provided, via the client interface, with a display for selecting a prompt from the set of prompts, and a selection of the prompt from the set of prompts may be received from the client interface. Further, the reception of the query to trigger the prompt may be based on the client interface receiving an indication of the selection of a prompt.

At 310, the computing device may transmit, to the augmentation service 235 via the client interface or via a computing system, a request for a set of grounding data associated with the first set of data from the one or more data sources linked to the prompt. In some examples, the augmentation service 235 may query the one or more data sources for the set of grounding data based on the reception of the first set of data via the query, where the set of grounding data is associated with the first set of data. In some cases, the augmentation service 235 may be configured to format data obtained from the one or more data sources for respective prompts of the set of prompts irrespective of a respective data source type associated with the one or more data sources.

In some examples, a first data transformer of a plurality of data transformers associated with the augmentation service 235 may transform the set of grounding data obtained from the one or more data sources may be transformed into a first data format. Moreover, a respective data transformer of the plurality of data transformers may be associated with a respective data format. Additionally, or alternatively, a first data refiner of a plurality of data refiners associated with the augmentation service 235 may adjust the set of grounding data within the first data format to be used for querying the LLM 225.

At 315, a prompt template for an LLM that is being configured on the computing device 205 may receive, from the augmentation service 235, the set of grounding data obtained from the one or more data sources of a plurality of data sources associated with the client interface. Moreover, the set of grounding data may include hierarchical context data from the one or more data sources. In some examples, the plurality of data sources may include internal databases, external databases, cloud-based platforms, application programming interfaces associated with respective services, customer relationship management systems, or any combination thereof. In some cases, the hierarchical context data of the set of grounding data may be based on metadata from the one or more data sources. Additionally, or alternatively, the plurality of data sources may include unstructured data sources, structured data sources, or both.

At 320, the computing device 205 may query the LLM 225 via the prompt using the first set of data and the set of grounding data obtained from the one or more data sources. In some examples, querying the LLM 225 via the prompt and the set of grounding data may be based on the adjustments to the set of grounding data performed via the augmentation service 235. At 325, the computing device 205 may receive, from the LLM 225, response to the query. At 330, the computing device 205 may provide, to the client interface, the response from the LLM for display via the client interface. As such, the client interface may display the response or output from the LLM to a respective user via the client interface that is used to transmit the query for triggering a prompt of the LLM.

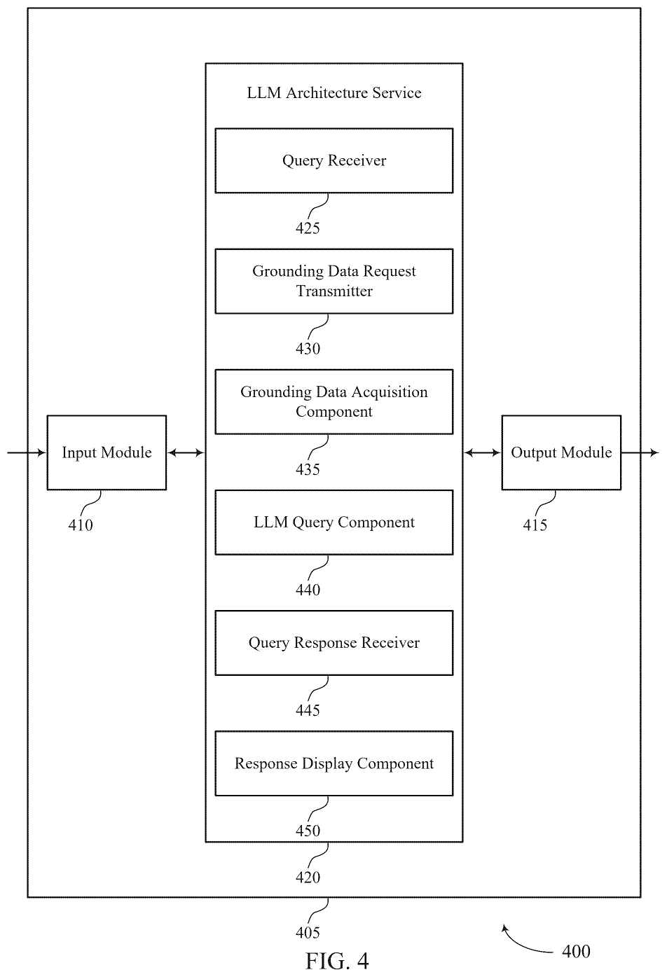

FIG. 4 shows a block diagram 400 of a device 405 that supports techniques for LLM prompt grounding in accordance with aspects of the present disclosure. The device 405 may include an input module 410, an output module 415, and an LLM architecture service 420. The device 405, or one or more components of the device 405 (e.g., the input module 410, the output module 415, the LLM architecture service 420), may include at least one processor, which may be coupled with at least one memory, to support the described techniques. Each of these components may be in communication with one another (e.g., via one or more buses).

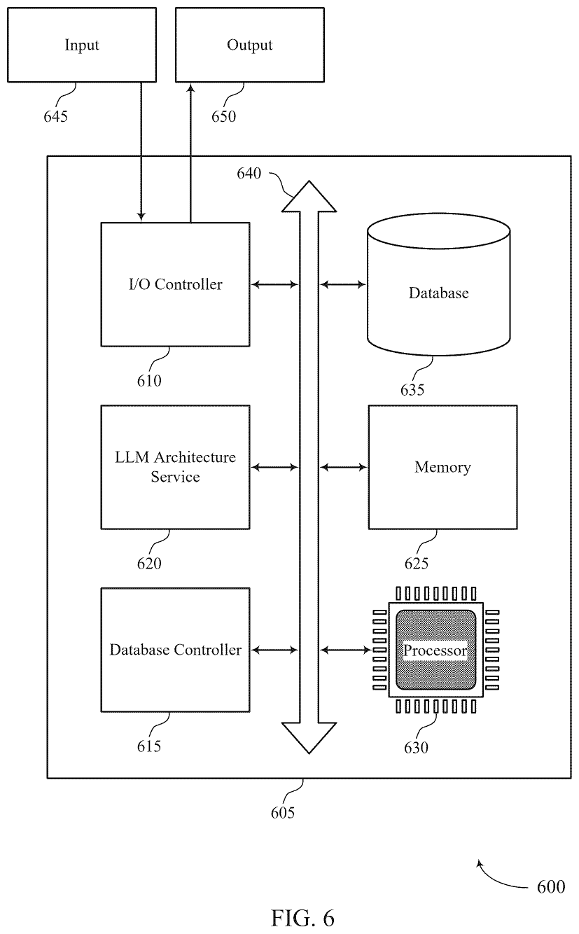

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the LLM architecture service 420 to support techniques for LLM prompt grounding. In some cases, the input module 410 may be a component of an input/output (I/O) controller 610 as described with reference to FIG. 6.

The output module 415 may manage output signals for the device 405. For example, the output module 415 may receive signals from other components of the device 405, such as the LLM architecture service 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the LLM architecture service 420 may include a query receiver 425, a grounding data request transmitter 430, a grounding data acquisition component 435, an LLM query component 440, a query response receiver 445, a response display component 450, or any combination thereof. In some examples, the LLM architecture service 420, or various components thereof, may be configured to perform various operations (e.g., receiving, monitoring, transmitting) using or otherwise in cooperation with the input module 410, the output module 415, or both. For example, the LLM architecture service 420 may receive information from the input module 410, send information to the output module 415, or be integrated in combination with the input module 410, the output module 415, or both to receive information, transmit information, or perform various other operations as described herein.

The LLM architecture service 420 may support data processing in accordance with examples as disclosed herein. The query receiver 425 may be configured to support receiving, via a client interface, a query to trigger a prompt of a set of prompts configured for a LLM (LLM), where the query is indicative of a first set of data from one or more data sources linked to the prompt. The grounding data request transmitter 430 may be configured to support transmitting, to an augmentation service, a request for a set of grounding data associated with the first set of data from the one or more data sources linked to the prompt. The grounding data acquisition component 435 may be configured to support receiving, from the augmentation service, the set of grounding data obtained from the one or more data sources of a set of multiple data sources associated with the client interface, where the set of grounding data includes hierarchical context data from the one or more data sources. The LLM query component 440 may be configured to support querying the LLM via the prompt using the first set of data and the set of grounding data obtained from the one or more data sources. The query response receiver 445 may be configured to support receiving, from the LLM, a response to the query. The response display component 450 may be configured to support providing, to the client interface, the response for display of the response via the client interface.

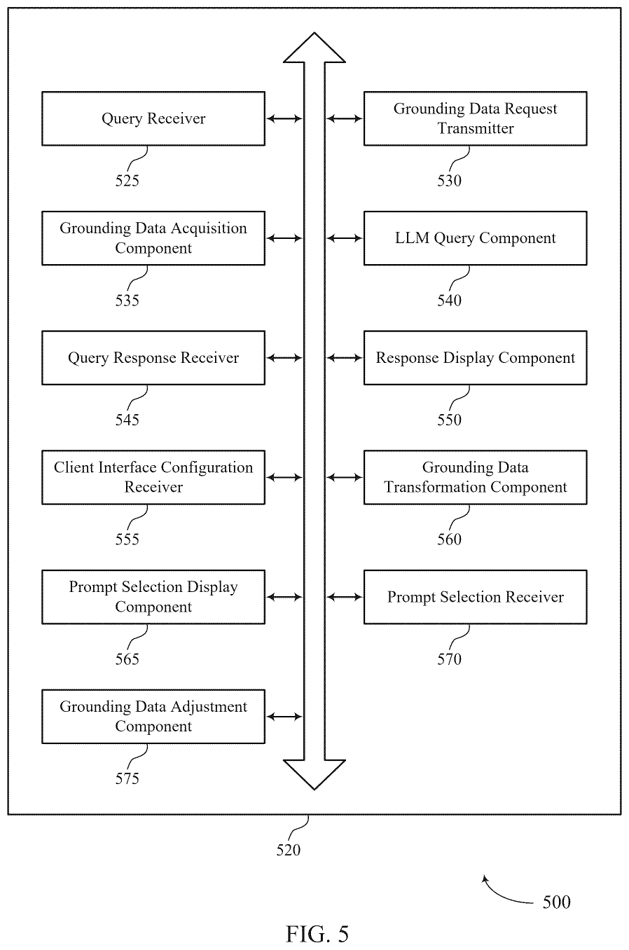

FIG. 5 shows a block diagram 500 of an LLM architecture service 520 that supports techniques for LLM prompt grounding in accordance with aspects of the present disclosure. The LLM architecture service 520 may be an example of aspects of an LLM architecture service or an LLM architecture service 420, or both, as described herein. The LLM architecture service 520, or various components thereof, may be an example of means for performing various aspects of techniques for LLM prompt grounding as described herein. For example, the LLM architecture service 520 may include a query receiver 525, a grounding data request transmitter 530, a grounding data acquisition component 535, an LLM query component 540, a query response receiver 545, a response display component 550, a client interface configuration receiver 555, a grounding data transformation component 560, a prompt selection display component 565, a prompt selection receiver 570, a grounding data adjustment component 575, or any combination thereof. Each of these components, or components of subcomponents thereof (e.g., one or more processors, one or more memories), may communicate, directly or indirectly, with one another (e.g., via one or more buses).

The LLM architecture service 520 may support data processing in accordance with examples as disclosed herein. The query receiver 525 may be configured to support receiving, via a client interface, a query to trigger a prompt of a set of prompts configured for a LLM (LLM), where the query is indicative of a first set of data from one or more data sources linked to the prompt. The grounding data request transmitter 530 may be configured to support transmitting, to an augmentation service, a request for a set of grounding data associated with the first set of data from the one or more data sources linked to the prompt. The grounding data acquisition component 535 may be configured to support receiving, from the augmentation service, the set of grounding data obtained from the one or more data sources of a set of multiple data sources associated with the client interface, where the set of grounding data includes hierarchical context data from the one or more data sources. The LLM query component 540 may be configured to support querying the LLM via the prompt using the first set of data and the set of grounding data obtained from the one or more data sources. The query response receiver 545 may be configured to support receiving, from the LLM, a response to the query. The response display component 550 may be configured to support providing, to the client interface, the response for display of the response via the client interface.

In some examples, the client interface configuration receiver 555 may be configured to support receiving, prior to receiving the query, a configuration of the client interface, the configuration including a selection of one or more query configurations, a selection of the set of prompts that is based on the selection of the one or more query configurations, an indication of one or more labels for the client interface, or any combination thereof, where reception of the query is based on reception of the configuration for the client interface.

In some examples, the grounding data transformation component 560 may be configured to support transforming, via the augmentation service, the set of grounding data obtained from the one or more data sources into a first data format, the set of grounding data being transformed into the first data format via a first data transformer of a set of multiple data transformers associated with the augmentation service, where a respective data transformer of the set of multiple data transformers is associated with a respective data format.

In some examples, the grounding data adjustment component 575 may be configured to support adjusting, via a first data refiner of a set of multiple data refiners associated with the augmentation service, the set of grounding data within the first data format to be used for querying the LLM, where querying the LLM via the prompt and the set of grounding data is based on adjustments to the set of grounding data.

In some examples, to support receiving the query, the prompt selection display component 565 may be configured to support providing, to the client interface, a display for selection of the prompt of the set of prompts. In some examples, to support receiving the query, the prompt selection receiver 570 may be configured to support receiving, from the client interface, the selection of the prompt of the set of prompts, where reception of the query to trigger the prompt is based on reception of the selection.

In some examples, to support receiving the set of grounding data obtained from the one or more data sources, the grounding data acquisition component 535 may be configured to support querying, via the augmentation service, the one or more data sources for the set of grounding data based on reception of the first set of data via the query, where the set of grounding data is associated with the first set of data.

In some examples, respective prompts of the set of prompts configured for the LLM are configured to perform respective tasks via the LLM.

In some examples, the set of multiple data sources includes internal databases, external databases, cloud-based platforms, application programming interfaces associated with respective services, customer relationship management systems, or any combination thereof.

In some examples, the hierarchical context data of the set of grounding data is based on metadata from the one or more data sources.

In some examples, the set of multiple data sources includes unstructured data sources, structured data sources, or both.

In some examples, the client interface is a graphical user interface, an application programming interface, or a combination thereof.

In some examples, the augmentation service is configured to format data obtained from the one or more data sources for respective prompts of the set of prompts irrespective of a respective data source type associated with the one or more data sources.

FIG. 6 shows a diagram of a system 600 including a device 605 that supports techniques for LLM prompt grounding in accordance with aspects of the present disclosure. The device 605 may be an example of or include components of a device 405 as described herein. The device 605 may include components for bi-directional data communications including components for transmitting and receiving communications, such as an LLM architecture service 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting techniques for LLM prompt grounding). The processor 630 may be an example of a single processor or multiple processors. For example, the device 605 may include one or more processors 630.

The LLM architecture service 620 may support data processing in accordance with examples as disclosed herein. For example, the LLM architecture service 620 may be configured to support receiving, via a client interface, a query to trigger a prompt of a set of prompts configured for a LLM (LLM), where the query is indicative of a first set of data from one or more data sources linked to the prompt. The LLM architecture service 620 may be configured to support transmitting, to an augmentation service, a request for a set of grounding data associated with the first set of data from the one or more data sources linked to the prompt. The LLM architecture service 620 may be configured to support receiving, from the augmentation service, the set of grounding data obtained from the one or more data sources of a set of multiple data sources associated with the client interface, where the set of grounding data includes hierarchical context data from the one or more data sources. The LLM architecture service 620 may be configured to support querying the LLM via the prompt using the first set of data and the set of grounding data obtained from the one or more data sources. The LLM architecture service 620 may be configured to support receiving, from the LLM, a response to the query. The LLM architecture service 620 may be configured to support providing, to the client interface, the response for display of the response via the client interface.

By including or configuring the LLM architecture service 620 in accordance with examples as described herein, the device 605 may support techniques for providing a unified and common architecture for generating accurate and contextually relevant outputs from generative AI applications to support an increase in accuracy, efficiency, and reliability of the generative AI applications.

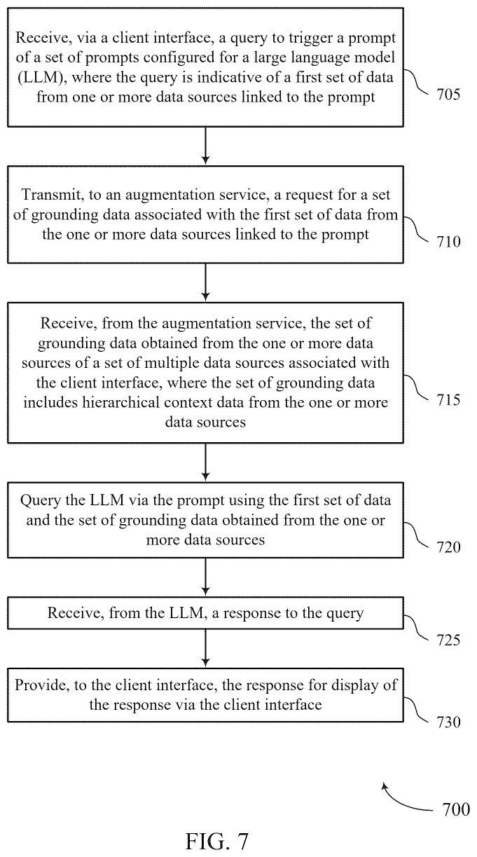

FIG. 7 shows a flowchart illustrating a method 700 that supports techniques for LLM prompt grounding in accordance with aspects of the present disclosure. The operations of the method 700 may be implemented by a computing device or its components as described herein. For example, the operations of the method 700 may be performed by a computing device as described with reference to FIGS. 1 through 6. In some examples, a computing device may execute a set of instructions to control the functional elements of the computing device to perform the described functions. Additionally, or alternatively, the computing device may perform aspects of the described functions using special-purpose hardware.

At 705, the method may include receiving, via a client interface, a query to trigger a prompt of a set of prompts configured for a LLM (LLM), where the query is indicative of a first set of data from one or more data sources linked to the prompt. The operations of 705 may be performed in accordance with examples as disclosed herein. In some examples, aspects of the operations of 705 may be performed by a query receiver 525 as described with reference to FIG. 5.

At 710, the method may include transmitting, to an augmentation service, a request for a set of grounding data associated with the first set of data from the one or more data sources linked to the prompt. The operations of 710 may be performed in accordance with examples as disclosed herein. In some examples, aspects of the operations of 710 may be performed by a grounding data request transmitter 530 as described with reference to FIG. 5.

At 715, the method may include receiving, from the augmentation service, the set of grounding data obtained from the one or more data sources of a set of multiple data sources associated with the client interface, where the set of grounding data includes hierarchical context data from the one or more data sources. The operations of 715 may be performed in accordance with examples as disclosed herein. In some examples, aspects of the operations of 715 may be performed by a grounding data acquisition component 535 as described with reference to FIG. 5.

At 720, the method may include querying the LLM via the prompt using the first set of data and the set of grounding data obtained from the one or more data sources. The operations of 720 may be performed in accordance with examples as disclosed herein. In some examples, aspects of the operations of 720 may be performed by an LLM query component 540 as described with reference to FIG. 5.

At 725, the method may include receiving, from the LLM, a response to the query. The operations of 725 may be performed in accordance with examples as disclosed herein. In some examples, aspects of the operations of 725 may be performed by a query response receiver 545 as described with reference to FIG. 5.

At 730, the method may include providing, to the client interface, the response for display of the response via the client interface. The operations of 730 may be performed in accordance with examples as disclosed herein. In some examples, aspects of the operations of 730 may be performed by a response display component 550 as described with reference to FIG. 5.

A method for data processing by an apparatus is described. The method may include receiving, via a client interface, a query to trigger a prompt of a set of prompts configured for a LLM (LLM), where the query is indicative of a first set of data from one or more data sources linked to the prompt, transmitting, to an augmentation service, a request for a set of grounding data associated with the first set of data from the one or more data sources linked to the prompt, receiving, from the augmentation service, the set of grounding data obtained from the one or more data sources of a set of multiple data sources associated with the client interface, where the set of grounding data includes hierarchical context data from the one or more data sources, querying the LLM via the prompt using the first set of data and the set of grounding data obtained from the one or more data sources, receiving, from the LLM, a response to the query, and providing, to the client interface, the response for display of the response via the client interface.

An apparatus for data processing is described. The apparatus may include one or more memories storing processor executable code, and one or more processors coupled with the one or more memories. The one or more processors may individually or collectively be operable to execute the code to cause the apparatus to receive, via a client interface, a query to trigger a prompt of a set of prompts configured for a LLM (LLM), where the query is indicative of a first set of data from one or more data sources linked to the prompt, transmit, to an augmentation service, a request for a set of grounding data associated with the first set of data from the one or more data sources linked to the prompt, receive, from the augmentation service, the set of grounding data obtained from the one or more data sources of a set of multiple data sources associated with the client interface, where the set of grounding data includes hierarchical context data from the one or more data sources, query the LLM via the prompt using the first set of data and the set of grounding data obtained from the one or more data sources, receive, from the LLM, a response to the query, and provide, to the client interface, the response for display of the response via the client interface.

Another apparatus for data processing is described. The apparatus may include means for receiving, via a client interface, a query to trigger a prompt of a set of prompts configured for a LLM (LLM), where the query is indicative of a first set of data from one or more data sources linked to the prompt, means for transmitting, to an augmentation service, a request for a set of grounding data associated with the first set of data from the one or more data sources linked to the prompt, means for receiving, from the augmentation service, the set of grounding data obtained from the one or more data sources of a set of multiple data sources associated with the client interface, where the set of grounding data includes hierarchical context data from the one or more data sources, means for querying the LLM via the prompt using the first set of data and the set of grounding data obtained from the one or more data sources, means for receiving, from the LLM, a response to the query, and means for providing, to the client interface, the response for display of the response via the client interface.

A non-transitory computer-readable medium storing code for data processing is described. The code may include instructions executable by one or more processors to receive, via a client interface, a query to trigger a prompt of a set of prompts configured for a LLM (LLM), where the query is indicative of a first set of data from one or more data sources linked to the prompt, transmit, to an augmentation service, a request for a set of grounding data associated with the first set of data from the one or more data sources linked to the prompt, receive, from the augmentation service, the set of grounding data obtained from the one or more data sources of a set of multiple data sources associated with the client interface, where the set of grounding data includes hierarchical context data from the one or more data sources, query the LLM via the prompt using the first set of data and the set of grounding data obtained from the one or more data sources, receive, from the LLM, a response to the query, and provide, to the client interface, the response for display of the response via the client interface.

Some examples of the method, apparatus, and non-transitory computer-readable medium described herein may further include operations, features, means, or instructions for receiving, prior to receiving the query, a configuration of the client interface, the configuration including a selection of one or more query configurations, a selection of the set of prompts that may be based on the selection of the one or more query configurations, an indication of one or more labels for the client interface, or any combination thereof, where reception of the query may be based on reception of the configuration for the client interface.

Some examples of the method, apparatus, and non-transitory computer-readable medium described herein may further include operations, features, means, or instructions for transforming, via the augmentation service, the set of grounding data obtained from the one or more data sources into a first data format, the set of grounding data being transformed into the first data format via a first data transformer of a set of multiple data transformers associated with the augmentation service, where a respective data transformer of the set of multiple data transformers may be associated with a respective data format.

In some examples of the method, apparatus, and non-transitory computer-readable medium described herein, adjusting, via a first data refiner of a set of multiple data refiners associated with the augmentation service, the set of grounding data within the first data format to be used for querying the LLM, where querying the LLM via the prompt and the set of grounding data may be based on adjustments to the set of grounding data.

In some examples of the method, apparatus, and non-transitory computer-readable medium described herein, receiving the query may include operations, features, means, or instructions for providing, to the client interface, a display for selection of the prompt of the set of prompts and receiving, from the client interface, the selection of the prompt of the set of prompts, where reception of the query to trigger the prompt may be based on reception of the selection.

In some examples of the method, apparatus, and non-transitory computer-readable medium described herein, receiving the set of grounding data obtained from the one or more data sources may include operations, features, means, or instructions for querying, via the augmentation service, the one or more data sources for the set of grounding data based on reception of the first set of data via the query, where the set of grounding data may be associated with the first set of data.

In some examples of the method, apparatus, and non-transitory computer-readable medium described herein, respective prompts of the set of prompts configured for the LLM may be configured to perform respective tasks via the LLM.

In some examples of the method, apparatus, and non-transitory computer-readable medium described herein, the set of multiple data sources includes internal databases, external databases, cloud-based platforms, application programming interfaces associated with respective services, customer relationship management systems, or any combination thereof.

In some examples of the method, apparatus, and non-transitory computer-readable medium described herein, the hierarchical context data of the set of grounding data may be based on metadata from the one or more data sources.

In some examples of the method, apparatus, and non-transitory computer-readable medium described herein, the set of multiple data sources includes unstructured data sources, structured data sources, or both.

In some examples of the method, apparatus, and non-transitory computer-readable medium described herein, the client interface may be a graphical user interface, an application programming interface, or a combination thereof.

In some examples of the method, apparatus, and non-transitory computer-readable medium described herein, the augmentation service may be configured to format data obtained from the one or more data sources for respective prompts of the set of prompts irrespective of a respective data source type associated with the one or more data sources.

The following provides an overview of aspects of the present disclosure:

Aspect 1: A method for data processing, comprising: receiving, via a client interface, a query to trigger a prompt of a set of prompts configured for a LLM (LLM), wherein the query is indicative of a first set of data from one or more data sources linked to the prompt; transmitting, to an augmentation service, a request for a set of grounding data associated with the first set of data from the one or more data sources linked to the prompt; receiving, from the augmentation service, the set of grounding data obtained from the one or more data sources of a plurality of data sources associated with the client interface, wherein the set of grounding data comprises hierarchical context data from the one or more data sources; querying the LLM via the prompt using the first set of data and the set of grounding data obtained from the one or more data sources; receiving, from the LLM, a response to the query; and providing, to the client interface, the response for display of the response via the client interface.

Aspect 2: The method of aspect 1, further comprising: receiving, prior to receiving the query, a configuration of the client interface, the configuration comprising a selection of one or more query configurations, a selection of the set of prompts that is based at least in part on the selection of the one or more query configurations, an indication of one or more labels for the client interface, or any combination thereof, wherein reception of the query is based at least in part on reception of the configuration for the client interface.

Aspect 3: The method of any of aspects 1 through 2, further comprising: transforming, via the augmentation service, the set of grounding data obtained from the one or more data sources into a first data format, the set of grounding data being transformed into the first data format via a first data transformer of a plurality of data transformers associated with the augmentation service, wherein a respective data transformer of the plurality of data transformers is associated with a respective data format.

Aspect 4: The method of aspect 3, further comprising: adjusting, via a first data refiner of a plurality of data refiners associated with the augmentation service, the set of grounding data within the first data format to be used for querying the LLM, wherein querying the LLM via the prompt and the set of grounding data is based at least in part on adjustments to the set of grounding data.

Aspect 5: The method of any of aspects 1 through 4, wherein receiving the query comprises: providing, to the client interface, a display for selection of the prompt of the set of prompts; and receiving, from the client interface, the selection of the prompt of the set of prompts, wherein reception of the query to trigger the prompt is based at least in part on reception of the selection.

Aspect 6: The method of any of aspects 1 through 5, wherein receiving the set of grounding data obtained from the one or more data sources comprises: querying, via the augmentation service, the one or more data sources for the set of grounding data based at least in part on reception of the first set of data via the query, wherein the set of grounding data is associated with the first set of data.

Aspect 7: The method of any of aspects 1 through 6, wherein respective prompts of the set of prompts configured for the LLM are configured to perform respective tasks via the LLM.

Aspect 8: The method of any of aspects 1 through 7, wherein the plurality of data sources comprises internal databases, external databases, cloud-based platforms, application programming interfaces associated with respective services, customer relationship management systems, or any combination thereof.

Aspect 9: The method of any of aspects 1 through 8, wherein the hierarchical context data of the set of grounding data is based at least in part on metadata from the one or more data sources.

Aspect 10: The method of any of aspects 1 through 9, wherein the plurality of data sources comprises unstructured data sources, structured data sources, or both.

Aspect 11: The method of any of aspects 1 through 10, wherein the client interface is a graphical user interface, an application programming interface, or a combination thereof.

Aspect 12: The method of any of aspects 1 through 11, wherein the augmentation service is configured to format data obtained from the one or more data sources for respective prompts of the set of prompts irrespective of a respective data source type associated with the one or more data sources.

Aspect 13: An apparatus for data processing, comprising one or more memories storing processor-executable code, and one or more processors coupled with the one or more memories and individually or collectively operable to execute the code to cause the apparatus to perform a method of any of aspects 1 through 12.

Aspect 14: An apparatus for data processing, comprising at least one means for performing a method of any of aspects 1 through 12.

Aspect 15: A non-transitory computer-readable medium storing code for data processing, the code comprising instructions executable by one or more processors to perform a method of any of aspects 1 through 12.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
receiving, via a client interface, a query to trigger a prompt of a set of prompts configured for a large language model (LLM), wherein the query is indicative of a first set of data from one or more data sources linked to the prompt;
transmitting, to an augmentation service, a request for a set of grounding data associated with the first set of data from the one or more data sources linked to the prompt;
receiving, from the augmentation service, the set of grounding data obtained from the one or more data sources of a plurality of data sources associated with the client interface, wherein the set of grounding data comprises hierarchical context data from the one or more data sources;
querying the LLM via the prompt using the first set of data and the set of grounding data obtained from the one or more data sources;
receiving, from the LLM, a response to the query; and
providing, to the client interface, the response for display of the response via the client interface.

2. The method of claim 1, further comprising:
receiving, prior to receiving the query, a configuration of the client interface, the configuration comprising a selection of one or more query configurations, a selection of the set of prompts that is based at least in part on the selection of the one or more query configurations, an indication of one or more labels for the client interface, or any combination thereof, wherein reception of the query is based at least in part on reception of the configuration for the client interface.

3. The method of claim 1, further comprising:
transforming, via the augmentation service, the set of grounding data obtained from the one or more data sources into a first data format, the set of grounding data being transformed into the first data format via a first data transformer of a plurality of data transformers associated with the augmentation service, wherein a respective data transformer of the plurality of data transformers is associated with a respective data format.

4. The method of claim 3, further comprising:
adjusting, via a first data refiner of a plurality of data refiners associated with the augmentation service, the set of grounding data within the first data format to be used for querying the LLM, wherein querying the LLM via the prompt and the set of grounding data is based at least in part on adjustments to the set of grounding data.

5. The method of claim 1, wherein receiving the query comprises:
providing, to the client interface, a display for selection of the prompt of the set of prompts; and
receiving, from the client interface, the selection of the prompt of the set of prompts, wherein reception of the query to trigger the prompt is based at least in part on reception of the selection.

6. The method of claim 1, wherein receiving the set of grounding data obtained from the one or more data sources comprises:
querying, via the augmentation service, the one or more data sources for the set of grounding data based at least in part on reception of the first set of data via the query, wherein the set of grounding data is associated with the first set of data.

7. The method of claim 1, wherein respective prompts of the set of prompts configured for the LLM are configured to perform respective tasks via the LLM.

8. The method of claim 1, wherein the plurality of data sources comprises internal databases, external databases, cloud-based platforms, application programming interfaces associated with respective services, customer relationship management systems, or any combination thereof.

9. The method of claim 1, wherein the hierarchical context data of the set of grounding data is based at least in part on metadata from the one or more data sources.

10. The method of claim 1, wherein the plurality of data sources comprises unstructured data sources, structured data sources, or both.

11. The method of claim 1, wherein the client interface is a graphical user interface, an application programming interface, or a combination thereof.

12. The method of claim 1, wherein the augmentation service is configured to format data obtained from the one or more data sources for respective prompts of the set of prompts irrespective of a respective data source type associated with the one or more data sources.

13. An apparatus for data processing, comprising:
one or more memories storing processor-executable code; and
one or more processors coupled with the one or more memories and individually or collectively operable to execute the code to cause the apparatus to:
receive, via a client interface, a query to trigger a prompt of a set of prompts configured for a large language model (LLM), wherein the query is indicative of a first set of data from one or more data sources linked to the prompt;
transmit, to an augmentation service, a request for a set of grounding data associated with the first set of data from the one or more data sources linked to the prompt;
receive, from the augmentation service, the set of grounding data obtained from the one or more data sources of a plurality of data sources associated with the client interface, wherein the set of grounding data comprises hierarchical context data from the one or more data sources;
query the LLM via the prompt using the first set of data and the set of grounding data obtained from the one or more data sources;
receive, from the LLM, a response to the query; and
provide, to the client interface, the response for display of the response via the client interface.

14. The apparatus of claim 13, wherein the one or more processors are individually or collectively further operable to execute the code to cause the apparatus to:
receive, prior to receiving the query, a configuration of the client interface, the configuration comprising a selection of one or more query configurations, a selection of the set of prompts that is based at least in part on the selection of the one or more query configurations, an indication of one or more labels for the client interface, or any combination thereof, wherein reception of the query is based at least in part on reception of the configuration for the client interface.

15. The apparatus of claim 13, wherein the one or more processors are individually or collectively further operable to execute the code to cause the apparatus to:
transform, via the augmentation service, the set of grounding data obtained from the one or more data sources into a first data format, the set of grounding data being transformed into the first data format via a first data transformer of a plurality of data transformers associated with the augmentation service, wherein a respective data transformer of the plurality of data transformers is associated with a respective data format.

16. The apparatus of claim 15, wherein the one or more processors are individually or collectively further operable to execute the code to cause the apparatus to:
adjust, via a first data refiner of a plurality of data refiners associate with the augmentation service, the set of grounding data within the first data format to be used for querying the LLM, wherein querying the LLM via the prompt and the set of grounding data is based at least in part on adjustments to the set of grounding data.

17. The apparatus of claim 13, wherein, to receive the query, the one or more processors are individually or collectively operable to execute the code to cause the apparatus to:
provide, to the client interface, a display for selection of the prompt of the set of prompts; and
receive, from the client interface, the selection of the prompt of the set of prompts, wherein reception of the query to trigger the prompt is based at least in part on reception of the selection.

18. The apparatus of claim 13, wherein, to receive the set of grounding data obtained from the one or more data sources, the one or more processors are individually or collectively operable to execute the code to cause the apparatus to:
query, via the augmentation service, the one or more data sources for the set of grounding data based at least in part on reception of the first set of data via the query, wherein the set of grounding data is associated with the first set of data.

19. The apparatus of claim 13, wherein the plurality of data sources comprises internal databases, external databases, cloud-based platforms, application programming interfaces associated with respective services, customer relationship management systems, or any combination thereof.

20. A non-transitory computer-readable medium storing code for data processing, the code comprising instructions executable by one or more processors to:
receive, via a client interface, a query to trigger a prompt of a set of prompts configured for a large language model (LLM), wherein the query is indicative of a first set of data from one or more data sources linked to the prompt;
transmit, to an augmentation service, a request for a set of grounding data associated with the first set of data from the one or more data sources linked to the prompt;
receive, from the augmentation service, the set of grounding data obtained from the one or more data sources of a plurality of data sources associated with the client interface, wherein the set of grounding data comprises hierarchical context data from the one or more data sources;
query the LLM via the prompt using the first set of data and the set of grounding data obtained from the one or more data sources;
receive, from the LLM, a response to the query; and
provide, to the client interface, the response for display of the response via the client interface.
